(19) United States
(12) Patent Application Publication
(10) Pub. No.: US 2014/0058830 A1
(43) Pub. Date: Feb. 27, 2014

(54) SELL THROUGH RATE EVALUATION FRAMEWORK FOR PRICING INVENTORY PROFILES IN ADVERTISING SYSTEMS

(71) Applicants: Jimmy Yang, Palo Alto, CA (US); Amita Gajewar, San Jose, CA (US); Dongni Chen, Sunnyvale, CA (US); Peiji Chen, Saratoga, CA (US)

(72) Inventors: Jimmy Yang, Palo Alto, CA (US); Amita Gajewar, San Jose, CA (US); Dongni Chen, Sunnyvale, CA (US); Peiji Chen, Saratoga, CA (US)

(73) Assignee: YAHOO! INC., SUNNYVALE, CA (US)

(21) Appl. No.: 13/590,475

(22) Filed: Aug. 21, 2012

(51) Int. Cl. G06Q 30/02

(52) U.S. Cl. 705/14.45

(57) ABSTRACT

A method for evaluating sell through rate in on-line guaranteed display advertising systems includes steps or acts of: receiving a set of eligible advertisement samples for a selected profile for a contract at different time durations; receiving an allocation plan representative of an allocation of future impressions of currently booked contracts; receiving eligible and available impressions for the selected profile at the specific time duration, using the set of eligible samples and the allocation plan; computing a historical sell through rate of the selected profile for the specific time duration as one minus a quotient of available impressions divided by eligible impressions; and computing a target sell through rate for a future time duration by applying the historical sell through rate to the future time duration.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of on-line pricing, and more particularly relates to the field of a simulation framework to analyze a sell-through rate.

### BACKGROUND OF THE INVENTION

In the field of display advertising it is necessary to compute an appropriate price to be used as a guideline to book guaranteed delivery (GD) contracts. When a pricing query arrives, the display advertising system first calculates the base price based on the booked price of historical contracts in a neighborhood and then makes adjustment according to changes in market conditions measured by current Sell Through Rate (STR) at that instant in time and target STR. The adjusted price is finally compared with the forecasted price at the Non Guaranteed Delivery (NGD) market to make sure the GD price is not lower than the NGD opportunity cost.

One of the key components of the pricing system component is Price Response in which the real production system monitors the market conditions measured as current Sell Through Rate (STR) and compares to the target STR to decide whether and by how much to adjust price to reach the target. Changes in market conditions are measured by the difference between the current STR and the target STR. The target STR of a particular lead time is set to the average historical STR of the same lead time. The target STR must be set to the value that reflects the historical market conditions.

### SUMMARY OF THE INVENTION

Briefly, according to an embodiment of the invention a method for evaluating sell through rate in on-line guaranteed display advertising systems includes steps or acts of: receiving a set of eligible advertisement samples for a selected profile for a contract at different time durations; receiving an allocation plan representative of an allocation of future impressions of currently booked contracts; receiving eligible and available impressions for the selected profile at the specific time duration, using the set of eligible samples and the allocation plan; computing a historical sell through rate of the selected profile for the specific time duration as one minus a quotient of available impressions divided by eligible impressions; and computing a target sell through rate for a future time duration by applying the historical sell through rate to the future time duration.

### BRIEF DESCRIPTION OF THE SEVERAL VIEWS OF THE DRAWINGS

To describe the foregoing and other exemplary purposes, aspects, and advantages, we use the following detailed description of an exemplary embodiment of the invention with reference to the drawings, in which:

FIG. 1 is a high level block diagram showing an information processing system configured to operate according to an embodiment of the present invention;

FIG. 2 is a flowchart of a method according to an embodiment of the invention;

FIG. 3 is a flowchart of a method according to an embodiment of the present invention;

FIG. 4 is a high-level block diagram of a computing device configured to operate according to an embodiment of the present invention; and

FIG. 5 is a chart depicting the calculation of historical sell-through rate, according to an embodiment of the invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

We describe an offline simulation framework and methodology used to analyze historical market conditions and trends in order to help set a goal for pricing products. The purpose of this offline simulation framework is to set an initial target Sell Through Rate for a product. The simulation framework involves major components such as Admission Control, Optimization and Supply Forecasting. The framework allows us to understand the market trend historically for various Internet properties. Following are definitions for the terminology used throughout this disclosure.

Contract. A contract represents the inventory of a specific inventory profile that an advertiser wants to buy. We also use the term query which carries a similar meaning.

Sample. A sample represents an inventory impression that is eligible to be served for a specific contract.

Lead time. The difference between the contract's query (or booking) time and start time. E.g. if a contract's query time is Jun. 1, 2009 and its start date is Jan. 1, 2010, then the lead time is seven months.

Supply forecast. For a given inventory profile, the supply forecast module returns the eligible samples based upon the historical impression data (supply forecast snapshot).

Optimizer. For a given list of contracts, the Optimizer module generates an allocation plan which encapsulates the information to be used at serving time. It can be used to determine the allocated inventory for each of the contracts in the list.

Admission Control. The framework makes use of an Admission Control module to compute the eligible and available number of impressions. The Admission Control module takes as input the allocation plan and samples for a given query (contract), and returns the number of eligible impressions and available impressions for the query.

The target STR must be set to the value that reflects the historical market conditions, which traditionally has not been recorded at the granularity required by the framework. We address this omission by using offline simulation based on real historical production data.

For a given inventory profile for contract (or query) c and delivery duration (t₁,t₂), we define its historical STR as [1—(availability/eligibility)], where availability and eligibility denote the available and eligible number of advertisement impressions for contract c during the time interval (t₁,t₂). Further, we define lead time as the difference between a contract's query (or booking) time and start time. For example, if a contract's query time is (Jun. 1, 2009) and its start date is (Jan. 1, 2010) then in this case lead time is seven months. The start date is the first date of the contract's delivery-duration.

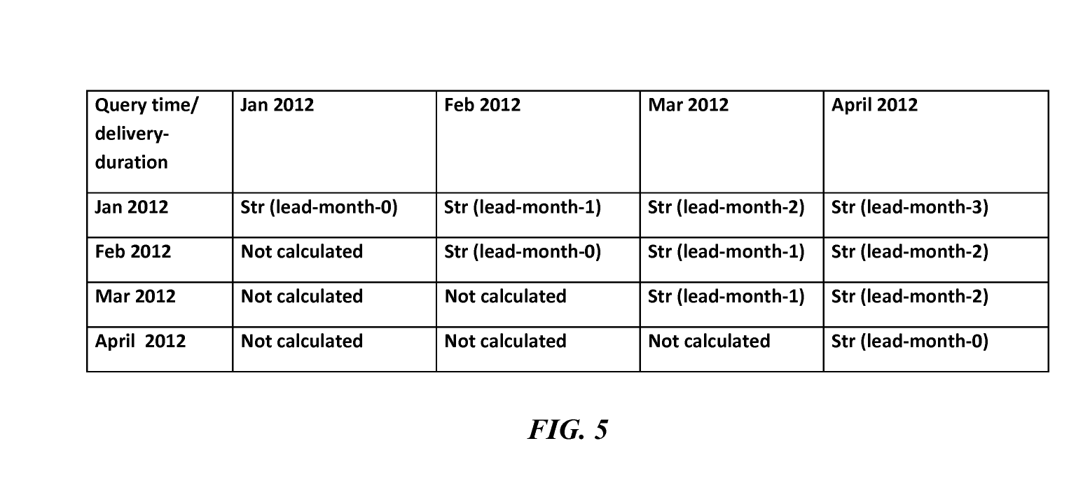

We then compute the historical sell-through-rate for the same query-duration but with different lead-times and for all eligible supply-forecast snapshots. Therefore, for a given (inventory-profile, delivery-duration) we may have multiple sell-through-rate values, each corresponding to a different lead-time (one for every valid supply-forecast-snapshot that was used). For example, suppose we want to query for inventory-profile=(mail, lrec) and delivery-duration is (January 2012, February 2012, March 2012, April 2012). And also assume that we have a supply-forecast snapshot for (January 2012, February 2012, March 2012, April 2012). Then we calculate historical sell-through-rate as shown in FIG. 5.

As FIG. 5 shows, the lead-month dictates how much in advance the query-time corresponds to the delivery-duration. If the delivery-time is ahead of query-time then the historical sell-through-rate is not computed for that combination. Now, for this inventory profile we set (lead-time, target-sell-through-rate) for different lead-times varying from 0-months to 11 months, using the historical-sell-through-rate for the corresponding lead-times. For example, in the table of FIG. 5, Target-sell-through-rate for the inventory profile (mail, lrec) with lead-time=0 months will be computed based upon four diagonal entries in the above table, each corresponding to the lead-month=0. It should be noted that the diagram shown in FIG. 5 is only for the purpose of providing a real-life example. The actual query-time and delivery-duration used in simulation can be different.

There is a distinction between an available impression and an eligible impression. This distinction is easily understood in terms of inventory. Eligible impressions are analogous to total inventory of advertisements for a given profile and duration; whereas available impressions are analogous to available inventory of advertisements for that profile and duration. For a given contract, the eligible impressions denote the total number of impressions that satisfy the targeting constraints imposed by contract. However, due to other contracts that are already booked in the systems, some of these eligible impressions may have been already allocated to be used for other contracts. The available impressions denote the number of impressions that are eligible and also not allocated yet to other contracts and as such are available for new contracts.

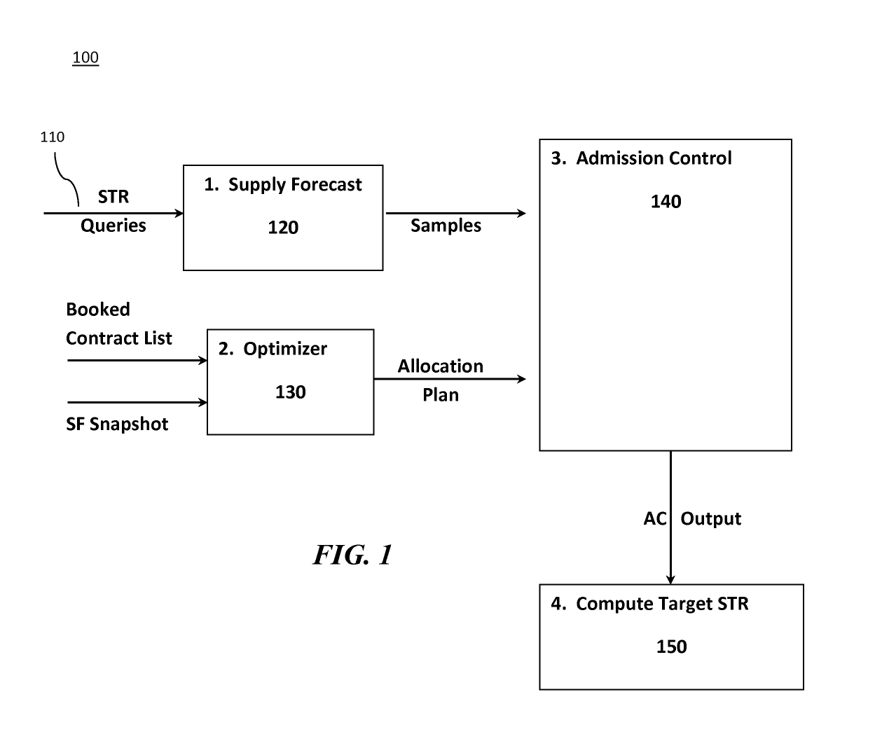

The offline simulation framework and methodology enables us to analyze and understand the market conditions and trends at a granular level that was previously not available. Referring to the drawings and to FIG. 1 in particular, we show a simplified illustration of a system architecture of the offline simulation framework 100 used to compute the STR. The main components of this system 100 are:

STR-Queries 110.

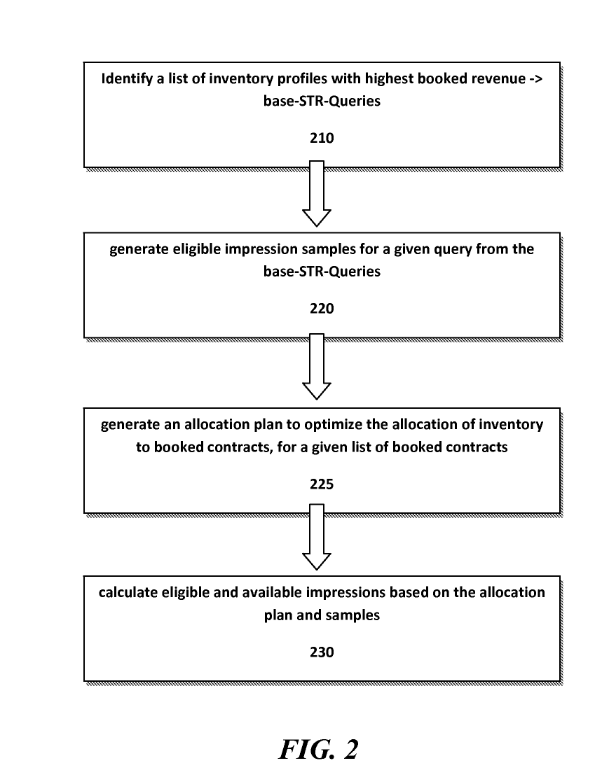

Referring now to the flowchart of FIG. 2, based upon the historical booked contracts, we identify a sample list of about 1000 inventory profiles with highest booked revenue in step 210. Our simulation framework can be advantageously used to compute STRs for any type of profile, yet we select here inventory profiles as an example. Those with knowledge in the art will appreciate that the selection of inventory profiles is for clarification purposes and to illustrate the inventive concepts, and not to limit the invention to any particular embodiment. These are the base-STR-Queries. An inventory profile is a set of targeting constraints on various attributes related to the impressions, for e.g., property=finance, position=lrec, country=US, etc.

Supply Forecast 120.

For a given query (contract) from the above list with specific delivery duration, the Supply Forecast module 120 is used with specific historical snapshot data to generate approximately 1000 eligible impression samples in step 220.

Optimizer 130.

For a given list of booked contracts at a snapshot in history, the Optimizer module 130 generates an allocation plan which is a compact representation of the allocation of future impressions (inventory) to the currently booked contracts in step 225. The allocation plan is computed by The Optimizer 130 with a multi-objective optimization function (one of the objectives could be revenue) to determine the allocation of inventory to the booked contracts in step 225. Admission Control 140. For an incoming query with inventory profile and delivery duration, we invoke the Admission Control module 140 to calculate the eligible and available impressions based on the updated allocation plan in step 230.

Target STR Computation 150.

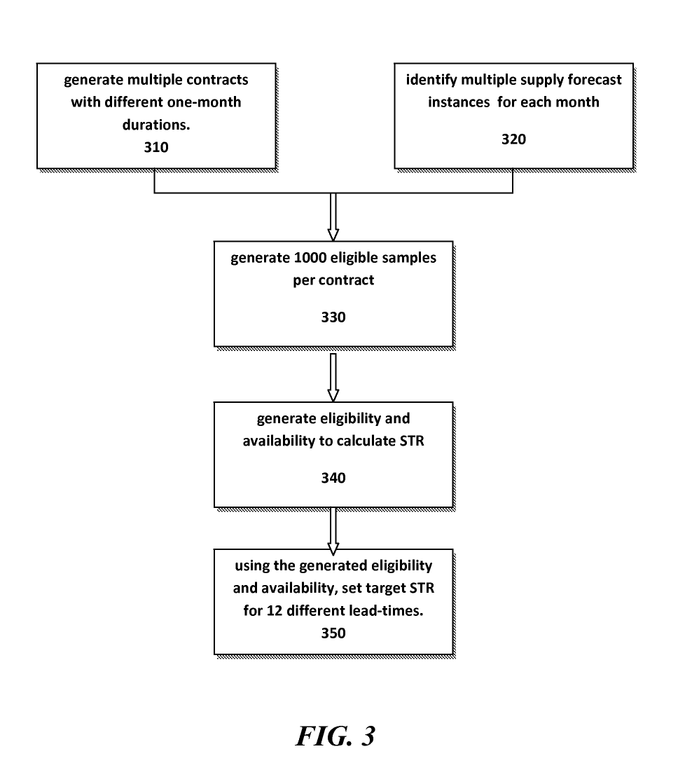

Referring now to the flowchart of FIG. 3, we describe the methodology used to calculate the historical STR curve for each of the contracts in base-STR-queries. In step 310, for each contract in the base-STR-Queries (1000 inventory profiles with highest booked revenue), we generate twenty-four contracts with different one-month durations in the range (Jul. 1, 2009-Jul. 31, 2009) . . . (Jun. 1, 2011-Jun. 30, 2011). As an example, assume the contract's inventory profile looks like “property=Mail, position=LREC.” Then, we generate 24 such contracts, each with an additional information of “duration-start=<date>, duration-end=<date>”; one for each month in a two-year period. Here, “duration-start” indicates the first day of the month and duration-end indicates the last day of the month. For example, if we decide to have 24 contracts starting January 2010 until December 2011, then the first contract will have “duration-start=Jan. 1, 2010, duration-end=Jan. 31, 2010”, the second contract will have “duration-start=Feb. 1, 2010, duration-end=Feb. 28, 2010”, and so on with the twenty-fourth contract having “duration-start=Dec. 1, 2011, duration-end=Dec. 31, 2011”.

Concurrently in step 320 we identify thirteen Supply Forecast 125 instances available in the duration (Jun. 1, 2009-Jun. 30, 2010) for each month. In step 330, for each of these supply forecast snapshots, we select the STR-Queries whose duration lies within next twelve month period and then we invoke Supply Forecast Module 125 to generate approximately 1000 eligible samples per contract.

Then in step 340 for each supply forecast instance and corresponding allocation plan and selected STR-queries, we invoke the Admission Control module to generate eligibility and availability in order to calculate the STR. As such, a given STR query may have up to thirteen different STR values for different query time corresponding to the supply-forecast instances. As an example, if a contract has duration (Jan. 1, 2010-Jan. 31, 2010), then we could use eight supply forecast instances (June 2009, . . . , January 2010) and as such have different STR values corresponding to different query time (June 2009, . . . , January 2010). Using this data, for each query in base-STR-Queries, in step 350 we set target STR for twelve different lead-times.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

Hardware Embodiment.

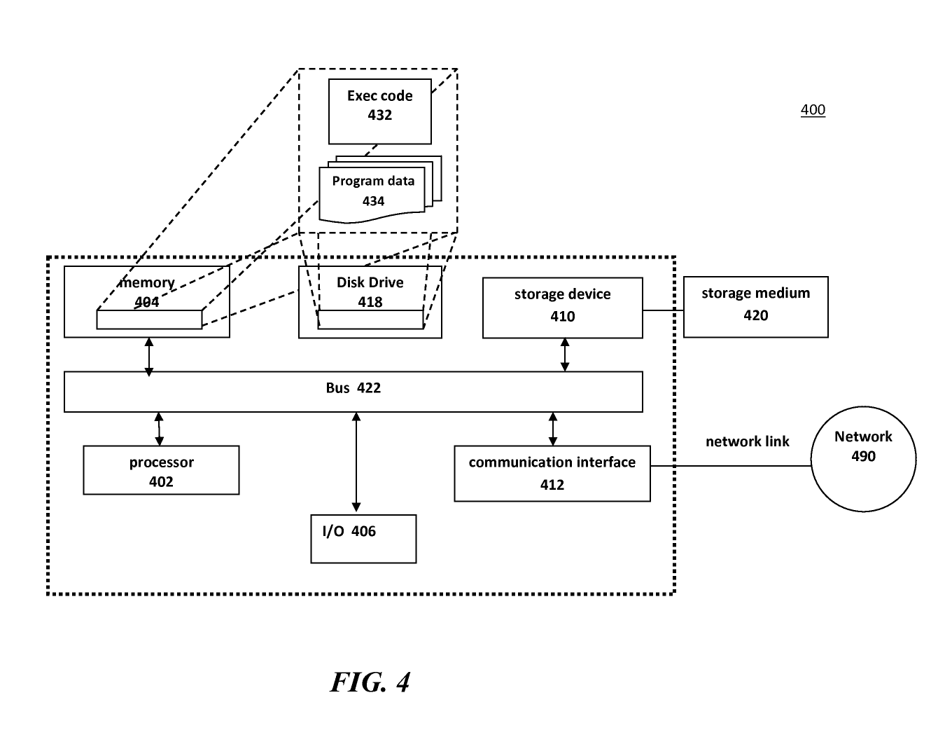

Referring now in specific detail to the drawings, and particularly FIG. 4, there is provide a simplified pictorial illustration of an information processing system in which the present invention may be implemented. For purposes of this invention, computer system 400 may represent any type of computer, information processing system or other programmable electronic device, including a client computer, a server computer, a portable computer, an embedded controller, a personal digital assistant, and so on. The computer system 400 may be a stand-alone device or networked into a larger system. Computer system 400, illustrated for exemplary purposes as a networked computing device, is in communication with other networked computing devices (not shown) via network 410. As will be appreciated by those of ordinary skill in the art, network 410 may be embodied using conventional networking technologies and may include one or more of the following: local area networks, wide area networks, intranets, public Internet and the like.

In general, the routines which are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the invention.

Throughout the description herein, an embodiment of the invention is illustrated with aspects of the invention embodied solely on computer system 400. As will be appreciated by those of ordinary skill in the art, aspects of the invention may be distributed amongst one or more networked computing devices which interact with computer system 400 via one or more data networks such as, for example, network 490. However, for ease of understanding, aspects of the invention have been embodied in a single computing device—computer system 400.

Computer system 400 includes processing device 402 which communicates with various input devices, output devices and network 490. The processor 402 is connected to a communication infrastructure 422 (e.g., a communications bus, cross-over bar, or network). The processor device 402 may be a general or special purpose microprocessor operating under control of computer program instructions executed from memory 404. The processor may include a number of special purpose sub-processors, each sub-processor for executing particular portions of the computer program instructions. Each sub-processor may be a separate circuit able to operate substantially in parallel with the other sub-processors. Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips. The memory may be partitioned or otherwise mapped to reflect the boundaries of the various memory subcomponents.

Memory 404 includes both volatile and persistent memory for the storage of: operational instructions for execution by CPU 402, data registers, application storage and the like. Memory 404 preferably includes a combination of random access memory (RAM), read only memory (ROM) and persistent memory such as that provided by a hard disk drive. The computer instructions/applications stored in memory 504 and executed by processor device 402.

The I/O subsystem 406 may comprise various end user interfaces such as a display, a keyboards, and a mouse. The I/O subsystem 406 may further comprise a connection to a network such as a local-area network (LAN) or wide-area network (WAN) such as the Internet. The computer system may include a display interface 408 that forwards graphics, text, and other data from the communication infrastructure 412 (or from a frame buffer not shown) for display on a display unit. The computer system also includes a main memory 404, preferably random access memory (RAM), and may also include a secondary memory 412. The secondary memory 412 may include, for example, a hard disk drive 414 and/or a removable storage drive 411, representing a floppy disk drive, a magnetic tape drive, an optical disk drive, etc. The removable storage drive 411 reads from and/or writes to a removable storage unit 418 in a manner well known to those having ordinary skill in the art. Removable storage unit 418, represents a floppy disk, a compact disc, magnetic tape, optical disk, etc. which is read by and written to by removable storage drive 411. As will be appreciated, the removable storage unit 418 includes a computer readable medium having stored therein computer software and/or data.

The computer system may also include a communications interface 412. Communications interface 412 allows software and data to be transferred between the computer system and external devices. Examples of communications interface 412 may include a modem, a network interface (such as an Ethernet card), a communications port, a PCMCIA slot and card, etc. Software and data transferred via communications interface 412 are in the form of signals which may be, for example, electronic, electromagnetic, optical, or other signals capable of being received by communications interface 412. These signals are provided to communications interface 412 via a communications path (i.e., channel). This channel carries signals and may be implemented using wire or cable, fiber optics, a phone line, a cellular phone link, an RF link, and/or other communications channels, either known or to be developed.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

We claim:

1. A method for evaluating sell through rate in on-line guaranteed display advertising systems, comprising:
using a processor device, performing steps of:
receiving a set of eligible advertisement samples for a selected profile for a contract at different time durations;
receiving an allocation plan representative of an allocation of future impressions of currently booked contracts;
receiving eligible and available impressions for the selected profile at the specific time duration, using the set of eligible samples and the allocation plan;
computing a historical sell through rate of the selected profile for the time duration as one minus a quotient of available impressions divided by eligible impressions; and
computing a target sell through rate for a future time duration by applying the historical sell through rate to the future time duration.

2. The method of claim 1 further comprising an initial step of:
selecting the profile for which the sell through rate is to be computed.

3. The method of claim 1 wherein the step of receiving the set of eligible samples comprises selecting future time durations for the set.

4. The method of claim 1 wherein the eligible impressions comprise a total inventory of advertisement impressions that satisfy targeting constraints imposed by the contract.

5. The method of claim 1 wherein the available impressions are available advertisement impressions that satisfy targeting constraints imposed by the contract.

6. The method of claim 1 further comprising:
selecting a specific time duration for the selected profile.

7. An information processing system for evaluating sell through rate in on-line guaranteed display advertising system, comprising:
a memory with computer-executable instructions stored therein, said computer-executable instructions comprising:
receiving a set of eligible advertisement samples for a selected profile for a contract at different time durations;
receiving an allocation plan representative of an allocation of future impressions of currently booked contracts;
receiving eligible and available impressions for the selected profile at the specific time duration, using the set of eligible samples and the allocation plan;
computing a historical sell through rate of the selected profile for the time duration as one minus a quotient of available impressions divided by eligible impressions; and
computing a target sell through rate for a future time duration by applying the historical sell through rate to the future time duration; and
a processor device executing the computer-executable instructions.

8. The information processing system of claim 7 wherein the computer-executable instructions further comprise:
an initial step of selecting the profile for which the sell through rate is to be computed.

9. The information processing system of claim 7 wherein receiving the set of eligible advertisement samples comprises selecting future time durations for the set.

10. The information processing system of claim 7 wherein the eligible impressions comprise a total inventory of advertisement impressions that satisfy targeting constraints imposed by the contract.

11. The information processing system of claim 7 wherein the available impressions are available advertisement impressions that satisfy targeting constraints imposed by the contract.

12. The information processing system of claim 7 wherein the computer-executable instructions further comprise:
selecting a specific time duration for the selected profile.

13. A computer program product comprising a non-transitory computer-readable storage medium with computer-executable instructions stored therein, said computer-executable instructions comprising:
receiving a set of eligible advertisement samples for a selected profile for a contract at different time durations;
receiving an allocation plan representative of an allocation of future impressions of currently booked contracts;
receiving eligible and available impressions for the selected profile at the specific time duration, using the set of eligible samples and the allocation plan;
computing a historical sell through rate of the selected profile for the time duration as one minus a quotient of available impressions divided by eligible impressions; and
computing a target sell through rate for a future time duration by applying the historical sell through rate to the future time duration.

14. The computer program product of claim 13 wherein the computer-executable instructions further comprise:
an initial step of selecting the profile for which the sell through rate is to be computed.

15. The computer program product of claim 13 wherein receiving the set of eligible advertisement samples comprises selecting future time durations for the set.

16. The computer program product of claim 13 wherein the eligible impressions comprise a total inventory of advertisement impressions that satisfy targeting constraints imposed by the contract.

17. The computer program product of claim 13 wherein the available impressions are available advertisement impressions that satisfy targeting constraints imposed by the contract.

18. The computer program product of claim 13 wherein the computer-executable instructions further comprise:
selecting a specific time duration for the selected profile.
